(19) United States
(12) Patent Application Publication
(10) Pub. No.: US 2005/0076701 A1
(43) Pub. Date: Apr. 14, 2005

(54) Method and apparatus for non-iterative calibration of current output in time-of-flight ranging systems

(76) Inventor: Adam Lomas, Trent Hills (CA)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/674,614

(22) Filed: Sep. 30, 2003

(51) Int. Cl. G01F 25/00

(52) U.S. Cl. 73/1.73

(57) ABSTRACT

A method and apparatus for calibrating a time-of-flight ranging or level measurement system coupled to a current loop. A first output current Is generated and the level of the first output current is measured. If the level is within an acceptable range, the level of the first output current is assigned to an internal current setting. A second output current is generated and the level of the second output current is measured. If the level is within an acceptable range, then the level of the second output current Is assigned to a second internal current setting. The first and second current settings are used to establish a range for controlling the current level in the current loop with the current level representing the process variable data, such as level measurement readings in a level measurement application.

### FIELD OF THE INVENTION

The present invention relates to time-of-flight ranging systems, and more particularly to a method and apparatus for a non-iterative calibration technique of current levels in a time-of-flight ranging system for a two-conductor current loop configuration.

### BACKGROUND OF THE INVENTION

Pulse-echo acoustic ranging systems, also known as time-of-flight ranging systems, are commonly used in level measurement applications. Pulse-echo acoustic ranging systems determine the distance to a reflector (i.e. reflective surface) by measuring how long after transmission of a burst of energy pulses the echoes or reflected pulses are received. Such systems typically use ultrasonic pulses or pulsed radar or microwave signals.

Time-of-flight ranging systems are commonly utilized In remote locations where process variable data is transmitted to another, e.g. central, location for further processing or collection. A common technique for transmitting such data is by a current loop. The value of the process variable is represented by the magnitude of a current passing through the loop, with the magnitude lying between predetermined minimum and maximum values, for example a minimum value around 4 mA and a maximum value around 20 mA, in what is termed a 4-20 mA current loop. Such a current loop has a high degree of noise Immunity and has also gained widespread industrial acceptance.

For proper operation, the time-of-flight or level measurement needs to be calibrated for the 4-20 mA current loop. Calibration comprises checking and configuring the device to provide a current level setting corresponding to a low output on the current loop, and another current level setting corresponding to a high output on the current loop. Known techniques comprise various iterative calibrations to arrive at a current level setting corresponding to a 4 mA output, and a current level setting corresponding to a 20 mA output.

### BRIEF SUMMARY OF THE INVENTION

The present invention provides a method and apparatus for calibrating the current outputs of a time-of-flight ranging system or level measurement system operating with a current loop.

In a first aspect, the present invention provides a method for calibrating a level measurement system operating with a current loop, the method comprises the steps of: outputting a first current; inputting a current output level corresponding to the first current; outputting a second current; inputting a current output level corresponding to the second current; determining whether said first current output level is within a first range; establishing a first current level setting corresponding to the first current output level if the first current output level Is within range; determining whether the second current output level Is within a second range; establishing a second current level setting corresponding to the second current output level if the second current output level Is within range; and using the first current level setting and the second current level for generating respective first and second current outputs on the current loop.

In another aspect, the present Invention provides a method for calibrating a level measurement device operating on a current loop, the current loop provides a communication channel having an output current level controllable between a first level and a second level for representing a process variable, the method comprises the steps of: outputting a first current level; inputting a current reading from the current loop; outputting a second current level; inputting a current reading from the current loop; determining whether the first current reading is within a first range; establishing a first current level setting corresponding to the first current reading if within the first range; determining whether the second current reading is within a second range; establishing a second current level setting corresponding to the second current reading if within the second range; utilizing the first current level setting to generate the output current for corresponding to the first level in the current loop; utilizing the second current level setting to generate the output current for corresponding to the second level in the current loop.

In a further aspect, the present invention provides a level measurement system for coupling to a remote receiver through a two-conductor loop carrying a current signal, the two-conductor loop provides a signal path for the level measurement system to transmit process variable data to the remote receiver, the level measurement system comprises. a process variable measurement stage comprising, a transducer for emitting energy pulses and coupling reflected energy pulses; a controller having a receiver stage and a transmitter stage; the transducer Is operatively coupled to the transmitter stage and Is responsive to the transmitter stage for emitting the energy pulses, and the receiver stage is operatively coupled to the transducer for receiving reflected energy pulses coupled by the transducer, and the controller includes a component for processing the receiver output and generating measurement data; a current loop interface module, the current loop Interface module has an output port for coupling to the current loop, and includes an input port coupled to the controller for receiving control signals to generate current signals on the current loop; a calibration module, the calibration module comprises a component for generating a first current signal for the current loop and a component for inputting a current level associated with the first current signal, the calibration module includes a component for generating a second current signal for the current loop and a component for inputting a current level associated with the second current signal; the calibration module further includes a component for assigning the first current level to a first current setting if the first current level is within a range, and a component for assigning the second current level to a second current setting if the second current level is within a range; the current loop interface module includes a memory component for storing the first and the second current settings, and the first and the second current settings provide control signals for generating the current signals for the current loop.

Other aspects and features of the present invention will become apparent to those ordinarily skilled in the art upon review of the following description of specific embodiments of the invention In conjunction with the accompanying drawings.

### BRIEF DESCRIPTION OF THE DRAWINGS

Reference is next made to the accompanying drawings which show, by way of example, embodiments of the present invention and In which:

FIG. 1 shows in diagrammatic form a level measurement system having a current calibration mechanism in accordance with the present invention; and

FIG. 2 shows in flow-chart a process for calibrating a level measurement system operating on a current loop In accordance with the present invention.

### DETAILED DESCRIPTION OF EMBODIMENTS OF THE INVENTION

The following detailed description of specific embodiments of the present invention does not limit the implementation of the invention to any particular programming language or signal processing architecture. In one embodiment, the present Invention is implemented, at least partly, using a digital signal processor. It will be understood that the present invention may be implemented using other architectures, including a microprocessor, a microcontroller, a field programmable logic device such as a field programmable gate array, discrete electronic components or combinations thereof. Any limitations presented herein as a result of a particular type of architecture or programming language are not intended as limitations of the present invention.

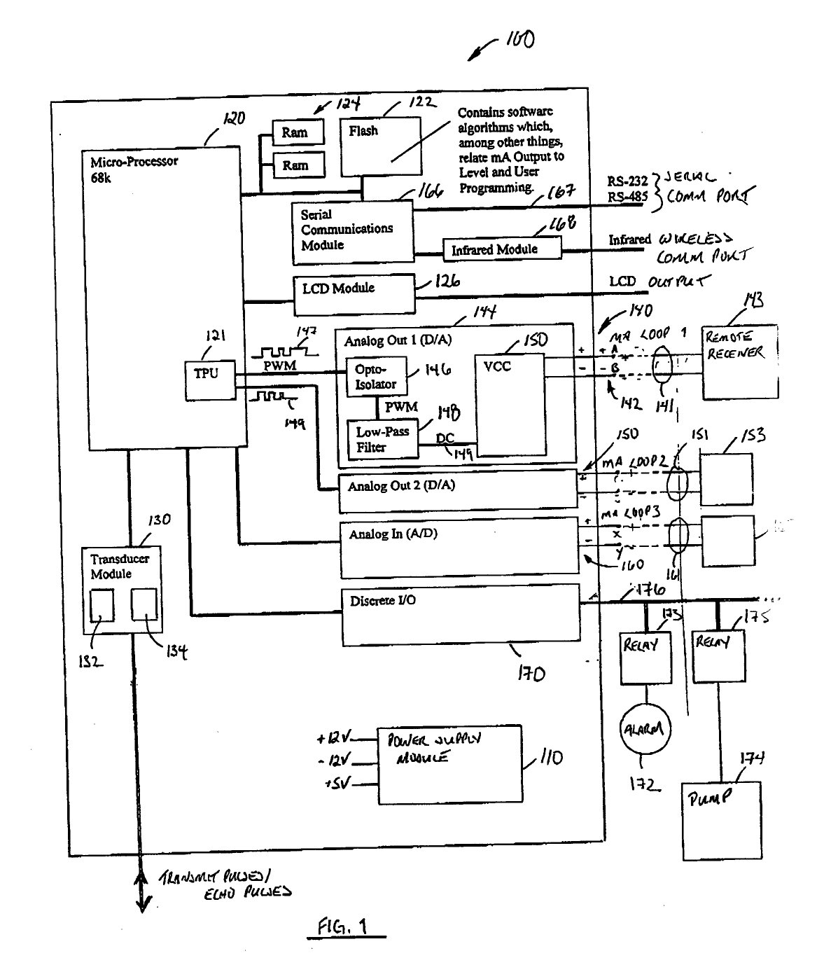

Reference is first made to FIG. 1 which shows In diagrammatic form a level measurement device 100 having a calibration mechanism according to the present invention. While the present invention is described in the context of time-of-flight ranging systems, and more specifically a level measurement system using ultrasound pulse echoes, it will be appreciated that the present invention has wider applicability to other types of time-of-flight ranging systems, such as radar or microwave based systems, and other types of process variable measurement devices, operating on a current loop. e.g. where the magnitude of the process variable is represented by the level of the current in the current loop.

The level measurement device 100 comprises a power supply 110, a microprocessor 120. The microprocessor 120 is associated with a program memory module 122 for storing a control program for the microprocessor 120, a random access memory (RAM) 124 providing scratch pad memory and temporary storage of variables. The program memory module 122 is implemented using an alterable non-volatile memory device such as FLASH memory. This allows the control program to upgraded, for example through a download from an external device via a communication channel. The FLASH memory 122 also provides storage for programmable operating parameters under power-down conditions. The device 100 may also include a display module 126, for example, a liquid crystal display or LCD. The LCD module 126 is controlled by the microprocessor 120 and provides a user with operational parameters and other information about the device 100.

For low power applications, such as those experienced for current loop operation, the microprocessor 120 is implemented using a low power semiconductor device, for example, a CMOS version of the Motorola 68000 series microprocessor. Such devices provide a “sleep” mode during which its internal clocks stop and the microprocessor 120 ceases execution of instructions while preserving all of its internal registers until such time as it receives a “wake up” signal.

The level measurement device 100 Includes a transducer 130 which comprises a transmitter driver component 132 and a receiver component 134. The transducer 130 may comprise, for example, a piezoelectric transducer. Under firmware control, the microprocessor 120 uses the transmitter driver component 132 to generate transmit pulses, for example, ultrasonic acoustic pulses in an ultrasound based pulse echo system. The ultrasonic acoustic energy is reflected by a target surface whose range Is to be determined back to the transducer 130 as an echo. The return energy picked up by the transducer 130 is applied to the input of the receiver 134. The received signal is gain controlled and logarithmically amplified in the receiver 134 before being sampled and digitized for processing by the microprocessor 120 to identify and verify the echo and calculate the range of the target surface using known techniques.

As shown in FIG. 1, the level measurement device 100 includes a 4-20 mA current loop control module indicated generally by reference 140. The 4-20 mA current loop control module 140 includes an output port 142 having terminals A and B which couple to two conductors in a current loop 141. The level measurement device 100 transmits the process variable data (e.g. measurements) to a remote receiver 143 via the current loop 141.

The measured range of the target surface is represented as a current level or magnitude on the current loop 141. For example, a low current level, e.g. 4 mA, may correspond to an empty vessel, and a high current level, e.g. 20 mA, may correspond to a full vessel, and values anywhere in between represent material levels between empty and full, for example, 12 mA represents 50% full. Digital data representing a desired loop current, in turn, representing the measured range of the target surface is generated and output from the microprocessor 120 to the 4-20 mA current loop control module 140. One of the functions of the loop control module 140 is to translate the digital information into analog form (as a function of the processed output of the transducer 130) and regulate the level or magnitude of current through the loop 141 between terminals A and B which is connected to a remote receiver current sensor (not shown) in the remote receiver 143. For example, if the digital signal corresponds to a full vessel, then a high level current signal Is generated for the current loop 141; if the digital signal corresponds to an empty vessel, then a low level current signal is generated for the current loop 141; and if the digital signal corresponds to a half full vessel, then a mid-level current signal Is generated for the current loop 141.

Referring to FIG. 1, the current loop control module 140 comprises a digital-to-analog converter 144 having an opto-coupler 146, a low-pass filter 148 and an output power circuit 150. The opto-coupler 146 receives a pulse width modulated signal or PWM 147 from the microprocessor 120. If the Motorola 68000 series device is used, the microprocessor 120 includes a time processor unit or TPU indicated by reference 121. Under firmware control, the TPU 121 generates PWM signals. The opto-coupler 146 Isolates the filter 148 and the power source 150 and provides a floating ground. The PWM signal 147 is averaged by the low pass filter 148 to provide a DC output signal 149. The DC output signal 149 controls the output power circuit 160 to transmit current signal ranging between a low level (e.g. 4 mA) on the current loop 141 to the remote receiver 143 and a high level (e.g. 20 mA) on the current loop 141 based on the PWM signal 147 generated by the microprocessor 120 operating under firmware control.

As shown in FIG. 1, the level measurement device 100 may include another current loop control module indicated by reference 150. The current loop control module 150 is coupled to another current loop 151 which provides an additional current loop-based communication channel. The current loop 151 may coupled to another remote device or another level measurement device (indicated generally by reference 153). The current loop control module 150 Is implemented in a similar fashion to the current loop control module 140 as described above.

Referring again to FIG. 1, the level measurement device 100 Includes a current loop input module indicated generally by reference 160. The current loop input module 160 includes an input port 162 having terminals X and Y which couple to two conductors In another current loop 161. The level measurement device 100 uses the input module 160 to receive process variable data (e.g. control/status information such as a level reading from another device or a volume measurement) from a remote device 153 coupled to the current loop 161. The current loop input module 160 is implemented in the form of an analog-to-digital converter (A/D) which converts the analog signal on the current signal (e.g. 4 mA signal or 20 mA signal) appearing on the current loop 161 into a corresponding digital signal which is inputted and processed by the microprocessor 120.

The level measurement device 100 may Include additional communication interfaces. As shown In FIG. 1, the level measurement device 100 includes a communication interface 166, and a digital input/output interface 170. The serial communication interface 166 supports a serial communication port 167 and a wireless communication port 168. The serial communication interface 166 may be implemented using conventional serial communication protocols such as the RS-232 and RS-485 standards. The wireless communication port 168 is implemented using a wireless protocol for an infrared channel. The communication interface 166 provides a two-way communication capability for added functionality, such as downloading firmware updates or patches for the program memory 122, operational or configuration parameters, and status/operational data uploads.

As also shown in FIG. 1, the level measurement device 100 includes a digital input/output control port 170. The digital input/output port 170 provides a digital control interface for peripheral devices, such as an alarm 172 and a pump 174. The alarm 172 is coupled to the digital port 170 through a relay 173. Similarly, the pump 174 is coupled to the digital port 170 through another relay 175. In an implementation with more than one peripheral device, the relays 173 and 175 are addressable and coupled to the digital control port 170 via a bus 176. The alarm 172 is activated, if for example, the level measured in the vessel being monitored rises above a threshold level. As part of the alarm condition, the microprocessor 120 may also turn on the pump 174 by actuating the relay 175. The pump 174 is operated until the level drops to an acceptable level. The alarm 172 is then turned off, and the pump 174 is also stopped by the microprocessor 120 through actuation of the respective relays 173 and 175.

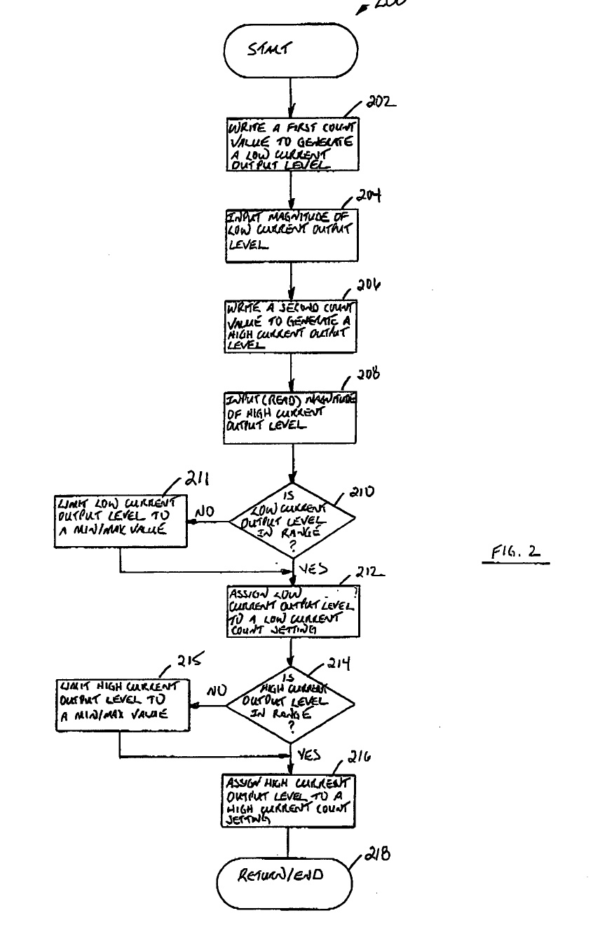

Reference is next made to FIG. 2 which shows a process indicated generally by reference 200 for calibrating the current output level signals for communicating via the current loop, for example, a 4 mA to 20 mA loop 141, 151 or 161 as described above with reference to FIG. 1. In one embodiment, a low current output level, i.e. approximately 4 mA, corresponds to a low level reading in the vessel, and a high current output level, i.e. approximately 20 mA corresponds to a high level reading in the vessel. Vessel reading levels falling between the low and the high levels are represented by current output levels ranging between the low and the high current output levels. It will be appreciated that the calibration procedure 200 is utilized by a user, e.g. technician, in addition to the factory calibration performed when the device 100 is assembled. There may also be instances where the calibration procedure 200 is used in place of factory calibration.

The first step in the process 200 according to this aspect comprises applying (i.e. writing) a first digital count value, Count 4, to the digital analog converter module 144 (or the digital converter module 150 if the device 100 includes more than one). The first digital count value Count 4 corresponds to a low current output level. A second digital count value Count 20 corresponding to a high current level is also stored in memory, i.e. either RAM 124 or program memory 122 (as a constant). The first digital count value Count 4 is written to the analog converter 144 in step 202. The process for writing the count value Count 4 comprises generating a PWM signal 147 (FIG. 1) in the TPU 121 which is then coupled and applied to the power source 150 as described above. Next in step 204, the resultant low current output level in the current loop 141 is measured and inputted to the microprocessor 120, for example, by a user utilizing a handheld calibration device and the infrared communication port 168. Next in step 206, the second digital count value Count 20 is written to the analog converter 144 to generate a high current output level in the loop 141. In step 208, the resultant high current output level In the current loop 141 is measured, inputted to the microprocessor 120 and stored in memory 124. If the measured low current output level is within an acceptable range of the respective desired low current output value, for example, 4 mA +/−2.0 mA (decision block 210), then the low output current response characteristic is established, and the low calibration procedure is completed by assigning the measured low current output value to a first count setting Actual 4 in step 212. If the measured low current output level is not within range, then the low current output level is adjusted to a minimum or maximum value in block 211, and the adjusted level is assigned to the first count setting Actual 4 in step 212. Similarly, if the measured high current output level is within an acceptable range of the respective desired high current output value, for example, 20 mA +/−2.0 mA (as determined in decision block 214), then the high output current response characteristic is established, and the high calibration procedure is completed by assigning the measured high current output value to a second (i.e. high) count setting Actual 20 in step 216. If the measured high current output level is not within the acceptable range, then the high current output level is adjusted to a minimum or maximum value in block 215, and the adjusted level is assigned to the second count setting Actual 20 in step 216. The calibration procedure is completed and the process returns/ends in step 218. It will be appreciated that the low calibration procedure and the high calibration procedure may be performed independently of each other.

In another embodiment, If the measured low current output level is out of range (decision block 210), the low current count setting is assigned a low current default value, for example, a default value established during calibration testing at the time of manufacturing. Similarly, if the measured high current output level is out of range (decision block 214), the high current count setting Is assigned a corresponding high current default value which may be set during manufacturing.

The present invention may be embodied In other specific forms without departing from the spirit or essential characteristics thereof. Certain adaptations and modifications of the invention will be obvious to those skilled in the art. Therefore, the above discussed embodiments are considered to be illustrative and not restrictive, the scope of the invention being indicated by the appended claims rather than the foregoing description, and all changes which come within the meaning and range of equivalency of the claims are therefore intended to be embraced therein.

1. A method for calibrating a level measurement system operating with a current loop, said method comprising the steps of:
outputting a first current level;
inputting a current output level corresponding to said first current level;
outputting a second current level;
inputting a current output level corresponding to said second current level;
determining whether said first current output level is within a first range;
establishing a first current level setting corresponding to said first current output level if said first current output level is within range;
determining whether said second current output level Is within a second range; establishing a second current level setting corresponding to said second current output level if said second current output level is within range; and
using said first current level setting and said second current level for generating respective first and second current outputs on the current loop.

2. The method as claimed in claim 1, wherein said first current level comprises a value stored in memory and said first current output corresponds to a low current output on the current loop.

3. The method as claimed in claim 2, wherein said second current level comprises another value stored in memory and said second current output corresponds to a high current output on the current loop.

4. The method as claimed in claim 3, wherein the current loop comprises a 4 to 20 mA loop, and said low current output is approximately 4 mA, and said high current output is approximately 20 mA.

5. The method as claimed in claim 4, wherein said first range is between 2 mA to 6 mA, and wherein said second range is between 18 mA to 22 mA.

6. The method as claimed In claim 1, further including the step of setting said first current level setting to a first default value if said first current output level is out of said first range.

7. The method as claimed in claim 6, further including the step of setting said second current level setting to a second default value if said second current output level is out of said second range.

8. The method as claimed in claim 7, wherein said first default value corresponds to the first current output having a magnitude of approximately 4 mA.

9. The method as claimed in claim 8, wherein said second default value corresponds to the second current output having a magnitude of approximately 20 mA.

10. A method for calibrating a level measurement device operating on a current loop, said current loop providing a communication channel having an output current level controllable between a first level and a second level for representing a process variable, said method comprising the steps of:
outputting a first current level;
inputting a current reading from the current loop;
outputting a second current level;
inputting a current reading from the current loop;
determining whether said first current reading is within a first range;
establishing a first current level setting corresponding to said first current reading if within said first range;
determining whether said second current reading Is within a second range;
establishing a second current level setting corresponding to said second current reading If within said second rang;
utilizing said first current level setting to generate the output current for Indicating the first level in the current loop;
utilizing said second current level setting to generate the output current for indicating the second level In the current loop.

11. The method as claimed In claim 10, wherein said first current level is generated based on a first Internal setting.

12. The method as claimed in claim 11, wherein said second current level is generated based on a second internal setting.

13. The method as claimed in claim 12, wherein said first internal setting comprises a value stored In memory and said first current level corresponds to the first level on the current loop.

14. The method as claimed in claim 13, wherein said second internal setting comprises another value stored in memory and said second current level corresponds to the second level on the current loop.

15. The method as claimed in claim 14, further including the step of setting said first current level setting to a first default value if said first current reading is out of range.

16. The method as claimed in claim 15, further including the step of setting said second current level setting to a second default value if said second current reading is out of said second range.

17. A level measurement system for coupling to a remote receiver through a two conductor loop carrying a current signal, the two-conductor loop providing a signal path for the level measurement system to transmit process variable data to the remote receiver, said level measurement system comprising:
a process variable measurement stage comprising,
a transducer for emitting energy pulses and coupling reflected energy pulses; and
a controller having a receiver stage and a transmitter stage;
said transducer being operatively coupled to said transmitter stage and being responsive to said transmitter stage for emitting said energy pulses, and said receiver stage being operatively coupled to said transducer for receiving reflected energy pulses coupled by said transducer, and said controller including a component for processing said receiver output and generating measurement data;
a current loop interface module, said current loop interface module having an output port for coupling to the current loop, and including an input port coupled to said controller for receiving control signals to generate current signals on the current loop;
a calibration module, said calibration module comprising a component for generating a first current signal for the current loop and a component for inputting a current level associated with said first current signal, said calibration module including a component for generating a second current signal for the current loop and a component for inputting a current level associated with said second current signal;
said calibration module further including a component for assigning said first current level to a first current setting If said first current level is within a range, and a component for assigning said second current level to a second current setting if said second current level is within a range;
said current loop interface module including a memory component for storing said first and said second current settings, and said first and said second current settings providing control signals for generating the current signals for the current loop.

18. The level measurement system as claimed in claim 17, further including a component for setting said first current setting to a default value if said first current level is out of said first range.

19. The level measurement system as claimed in claim 18, further including another component for setting said second current setting to a default value if said second current level is out of said second range.

20. The level measurement system as claimed in claim 19, wherein said first default value corresponds to a current level of approximately 4 mA.

21. The level measurement system as claimed in claim 20, wherein said second default value corresponds to a current level of approximately 20 mA.
